(19) United States
(12) Patent Application Publication
(10) Pub. No.: US 2025/0117559 A1
(43) Pub. Date: Apr. 10, 2025

(54) METHOD AND APPARATUS FOR SIMULATION MODELLING

(71) Applicant: TEXAS INSTRUMENTS INCORPORATED, Dallas, TX (US)

(72) Inventors: Ankush Ankush, Bengaluru (IN); Venkateswaran Padmanabhan, Bengaluru (IN); Aayush Garg, Bengaluru (IN); Guha Lakshmanan, Bengaluru (IN); Avishek Pal, Bengaluru (IN)

(21) Appl. No.: 18/481,866

(22) Filed: Oct. 5, 2023

(51) Int. Cl. G06F 30/3308

(52) U.S. Cl. CPC G06F 30/3308

(57) ABSTRACT

A method comprises creating an electronic circuit design having a plurality of electronic components, simulating operation of the electronic circuit design, and creating a behavior model of the electronic circuit design. The method further comprises eliminating one or more data points created in the behavior model to generate a trimmed behavior model, generating a real number model based on the trimmed behavior model, the real number model comprising a plurality of weights, and generating a simulation model based on the plurality of weights.

### BACKGROUND

Modern circuit design often involves electronic design automation (EDA) tools to simulate and verify circuit operation and interconnections. Simulating the circuit design may be used to validate expected operational conditions of the circuit design.

For example, a new product may be requested by an external third party of a product supplier. The third party might be a customer of the supplier. In one product development scenario, the product supplier receives the product specifications from the third party and designs and produces a physical product for review by the third party. Often, an electronic simulation file is provided together with the physical part to allow the third party to simulate operation of the product using EDA tools. If modifications are needed after the product has been delivered with its accompanying simulation file, the product supplier receives the feedback changes and modifies the product accordingly. Based on the modified product, a new simulation file is provided together with the modified physical product to the third party. In this scenario, delivery of the electronic simulation file together with a physical product relies on the physical product being completed for delivery to the third party. The design, feedback, redesign process can extend across multiple product revisions and extends the time of delivery to the third party for product testing. This scenario results in a long transition time from the initial request through to final stage of sending the requested product to the third party.

### SUMMARY

In accordance with one aspect, a method comprises creating an electronic circuit design having a plurality of electronic components, simulating operation of the electronic circuit design, and creating a behavior model of the electronic circuit design. The method further comprises eliminating one or more data points created in the behavior model to generate a trimmed behavior model, generating a real number model based on the trimmed behavior model, the real number model comprising a plurality of weights, and generating a simulation model based on the plurality of weights.

In accordance with another aspect, an apparatus comprises one or more computer readable storage media and program instructions stored on the one or more computer readable storage media. The program instructions executable by a processing system to direct the processing system to simulate operation of an electronic circuit design, create a behavior model of the electronic circuit design, the behavior model comprising a plurality of data points, and trim at least one data point from the behavior model to reduce a size of the behavior model. The program instructions further direct the processing system to generate a real number model based on the trimmed behavior model, the real number model comprising a plurality of weights and generate a simulation model based on the plurality of weights.

### BRIEF DESCRIPTION OF THE DRAWINGS

In the drawings:

FIG. 1 illustrates a block diagram of a product development process according to one or more disclosed implementations.

FIG. 2 is a block diagram of a process for generating a simulation model according to one or more disclosed implementations.

FIG. 3 is a flow diagram of the process of FIG. 2 according to one or more disclosed implementations.

FIG. 4 is a block diagram of a process for model planning according to one or more disclosed implementations.

FIG. 5 illustrates a waveform diagram illustrating electrical and timing characteristics according to one or more disclosed implementations.

FIG. 6 is a flow diagram of a decimation process according to one or more disclosed implementations.

FIG. 7 illustrates a block diagram of a simulation model extraction according to one or more disclosed implementations.

FIG. 8 illustrates a flow diagram of a process for simulation model extraction according to one or more disclosed implementations.

FIG. 9 is a block diagram of an example computer system that may be used to perform according to one or more disclosed implementations.

### DETAILED DESCRIPTION

In the following description, for purposes of explanation, numerous specific details are set forth in order to provide a thorough understanding of the examples disclosed herein. It will be apparent, however, to one skilled in the art that the disclosed example implementations may be practiced without these specific details. In other instances, structure and devices are shown in block diagram form in order to avoid obscuring the disclosed examples. Moreover, the language used in this disclosure has been principally selected for readability and instructional purposes and may not have been selected to delineate or circumscribe the inventive subject matter, resorting to the claims being necessary to determine such inventive subject matter. Reference in the specification to “one example” or to “an example” means that a particular feature, structure, or characteristic described in connection with the examples is included in at least one implementation.

As used herein, the term “medium” refers to one or more non-transitory physical media that together store the contents described as being stored thereon. Examples may include non-volatile secondary storage, read-only memory (ROM), and/or random-access memory (RAM).

As used herein, the term “application” refers to one or more computing modules, programs, processes, workloads, threads and/or a set of computing instructions executed by a computing system. Example implementations of applications and functions include software modules, software objects, software instances and/or other types of executable code.

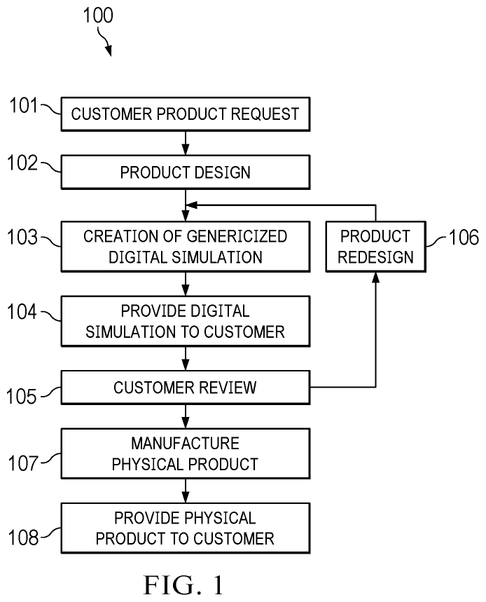

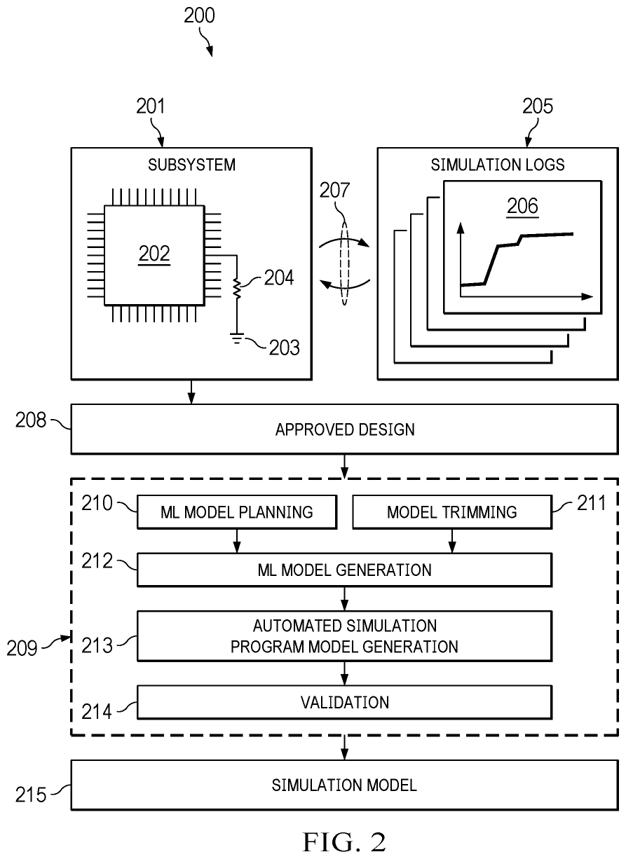

FIG. 1 illustrates a block diagram 100 of a product development process according to an embodiment. At a first block 101 a supplier's customer may request that the supplier develop and provide a product for purchase from the supplier. The customer's request can include product specifications defining the desired characteristics of the products, such as performance metrics under certain conditions. Based on the specifications of the product request, the supplier designs the product at block 102. For example, the supplier can create a circuit model of the product and/or a physical layout of the product. Prior to producing a physical implementation of the product (e.g., a prototype), the supplier may prefer to prepare a digital simulation of the product for testing by the customer to ensure that the designed product meets the customer's needs. Accordingly, based on this disclosure as discussed in the figures below, a genericized and non-discoverable simulation file can be created at block 103 to be provided by the supplier to the customer at block 104. The genericized and non-discoverable simulation file created as described herein (e.g., FIGS. 2-9) allows the supplier to provide a simulation file that simulates the functions and/or characteristics of the designed product without disclosing the details of the product's design. In this manner, the supplier can protect its design from being discovered by the customer or third parties because the simulation file may not be easily reverse engineered to arrive at the protected design. In other words, the simulation file may not include the full circuit design and layout for the product. Instead, a simulation file can model the performance of the product in, for example, an EDA simulator.

Based on the provided generic simulation file, the customer reviews the simulation operation of the product at block 105 and provides feedback to the supplier indicating whether the designed product is ready for production or whether the customer will request any additional changes. The customer can run simulations of the product and/or a larger system using the simulation file received from the supplier. If additional changes are requested by the customer, the supplier redesigns the product accordingly at block 106, and the process 100 returns to block 103 for creating another genericized simulation file based on the revised design. The supplier can create a revised design that incorporates or accommodates the additional changes requested by the customer. The supplier then creates the updated genericized simulation file based on the revised design. This process may result in a faster turnaround time and shorter wait times because of quick back-and-forth interactions between the supplier and the customer, as compared to producing an updated product every time the customer submits an updated design.

In response to receiving feedback from the customer that the designed or redesigned product is ready for manufacture and sale (e.g., by approving the simulation file), the supplier manufactures the physical product based on the design at block 107 and provides the physical product to the customer for sale at block 108. The supplier can manufacture the physical product by at least fabricating the approved design into a semiconductor wafer to produce an integrated circuit. In some examples, the supplier or a foundry at the direction of the supplier creates (e.g., etches) the approved design onto a semiconductor wafer. The product may include an analog circuit, a digital circuit, and/or a mixed-signal circuit, which is fabricated based on the approved design.

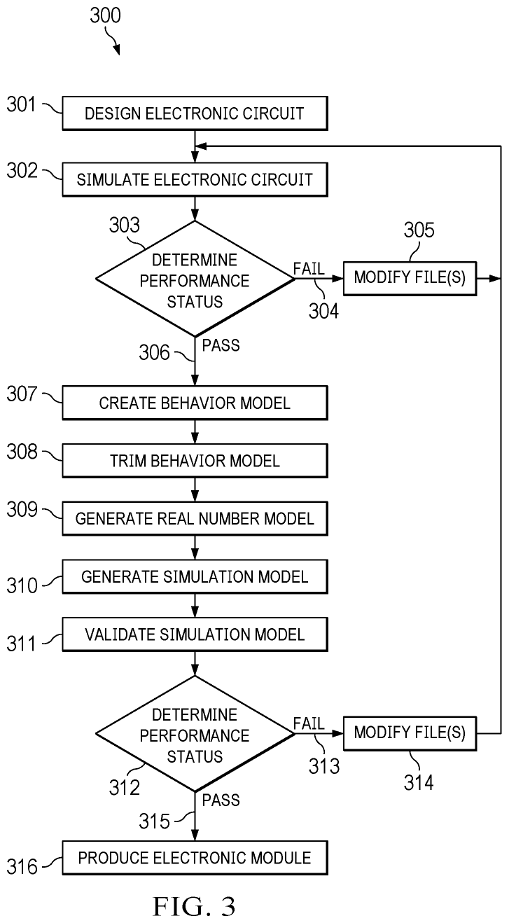

FIG. 2 is a block diagram of a process 200 for generating a simulation model according to an embodiment. A flow diagram 300 of the process 200 is illustrated in FIG. 3 according to an embodiment. Referring to FIGS. 2 and 3, an electronic circuit (e.g., subsystem) 201 is designed at block 301. The design for the electronic circuit 201 may be based on product design specifications provided to a supplier by a third party that desires the supplier to develop and produce a new product or an improved product, for example. Alternatively, the electronic circuit 201 may be a new design desired by the supplier to showcase a new product for sale to potential customers. The electronic circuit 201 may be electronically designed within an electronic circuit design environment or may be physically designed at a design workstation. FIG. 2 illustrates an electronic component 202 such as an application-specific integrated circuit (ASIC) or other type of processor having an input or output line coupled to ground 203 via a resistor 204 in the simplified block diagram design. However, the electronic circuit 201 itself will typically be more complex, and the block diagram symbols illustrated in FIG. 2 are merely a representation of the more complex circuit under design.

The designed electronic circuit 201 may undergo simulation 205 at block 302 at one or more stages of development. The simulation 205 can be used to provide simulation logs 206 illustrating simulated operation of the electronic circuit 201 under one or more operational scenarios. Based on the simulation logs 206, a performance status of the electronic circuit 201 is determined at block 303 for the simulated design stage. If the performance status indicates that additional design work is to be performed 304, the electronic circuit 201 is modified accordingly to address desired design changes at block 305. The modified electronic circuit 201 may be again simulated at block 302 for an iterative process 207 of performance status review (e.g., blocks 302-305).

Based on the performance status indicating that the design work is finished and has passed 306 appropriate operational and functional design parameters, an approved design 208 is provided to an operation 209 for generating a simulation file of the approved design 208 prior to producing a physical product incorporating the designed electronic circuit 201. According to embodiments of this disclosure, the generated simulation file provides accurate data for simulating the approved electronic circuit 208 using EDA tools while disguising how the components of the approved electronic circuit 208 are arranged to produce the simulation results. As discussed herein, the simulation file generating operation 209 incorporates machine learning (ML) to produce simulation models that reproduce the operation of the approved electronic circuit 208 during simulation. While the simulation models reproduce correct simulation operation of the approved electronic circuit 208, the simulation models hide the arrangement of the designed electronic components (e.g., components 202-204) within the simulation file. As such, a review of the simulation file fails to divulge the approved electronic circuit 208. In this manner, prior to producing a physical product based on the approved electronic circuit 208, a genericized and non-discoverable simulation file generated based on this disclosure may be provided to an external third party for simulation review without revealing the electronic circuit design. When the third party receives the simulation file, the actual design of the product may be hidden such that the third party cannot discover the design details.

In one step of the simulation file generating operation 209, ML model planning 210 is performed to create a behavior model at block 307. The ML model planning is used to create a monolithic device top of the approved electronic circuit 208 using individual block models. Electrical and timing characteristics are segmented or separated, and a device feature hierarchical approach is used to combine block level models.

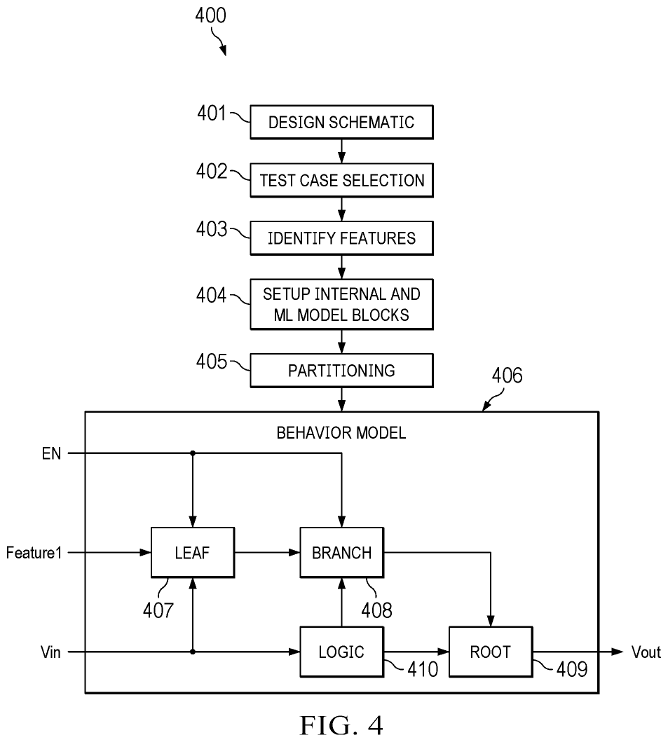

FIG. 4 shows a block diagram of a process 400 illustrating features of the ML model planning 210 according an embodiment. Based on a design schematic 401 such as the approved electronic circuit 208 of FIG. 2, a functional test case or behavioral function of the approved electronic circuit 208 is selected 402. Examples of functional test cases include powerup, enable toggling, fault conditions, and recovery conditions. Other types of functional test cases are, however, also possible. Based on the selected functional test case, features of the design schematic 401 needed or useful for the selected functional test case are identified 403. Identified features may include overvoltage (OV), undervoltage lockout (UVLO), over temperature protection (TSD), auto-retry functionality, and other features. In one embodiment, the auto-retry functionality re-enables a component after a pre-set time that has been disabled due to a fault condition (e.g., overcurrent). Both internal and ML model blocks are setup 404 based on the identified features. The OV feature may be set up with an OVLO internal block, the UVLO feature may be set up with an EN/UVLO internal block, and the auto-retry feature may be set up with a relevant resistor-capacitor (RC) model. In addition, the TSD feature may be set up with a logical expression block.

Partitioning 405 is implemented to internal and ML model blocks into a behavior model 406 (e.g., a monolithic model top) including one or more leaf blocks 407, one or more branch blocks 408, one or more root blocks 409, and one or more logic expression blocks 410. The leaf, branch, and root blocks 407-409 are electrical block models for assigning electrical characteristics. The logic expression blocks 410 are timing block models for assigning timing characteristics. The leaf block 407 may represent models that are built using device top level signals (e.g., Vin, enable (EN), OV, UVLO, etc.) only. The leaf block 407 may represent a leaf block model configured to receive signals provided externally to the behavior model and to generate signals provided internally within the behavior model 406. The branch block 408 may have one or more interdependencies with specific blocks within the behavior model 406. The branch block 408 may represent a branch block model configured to receive signals provided internally within the behavior model and to generate signals provided internally within the behavior model 406. The root block 409 may be a model with final output (e.g., Vout) of the device. The root block 409 may represent a root block model configured to receive signals provided externally to or internally within the behavior model and to generate an output signal provided externally to the behavior model 406. The logic expression block 410 may be device counter or timer features that are handled as logic equations. The logic expression block 410 may represent a logic expression block model or a timing model block configured to receive signals provided externally to or internally within the behavior model and to generate counter or timer signals provided internally within the behavior model 406.

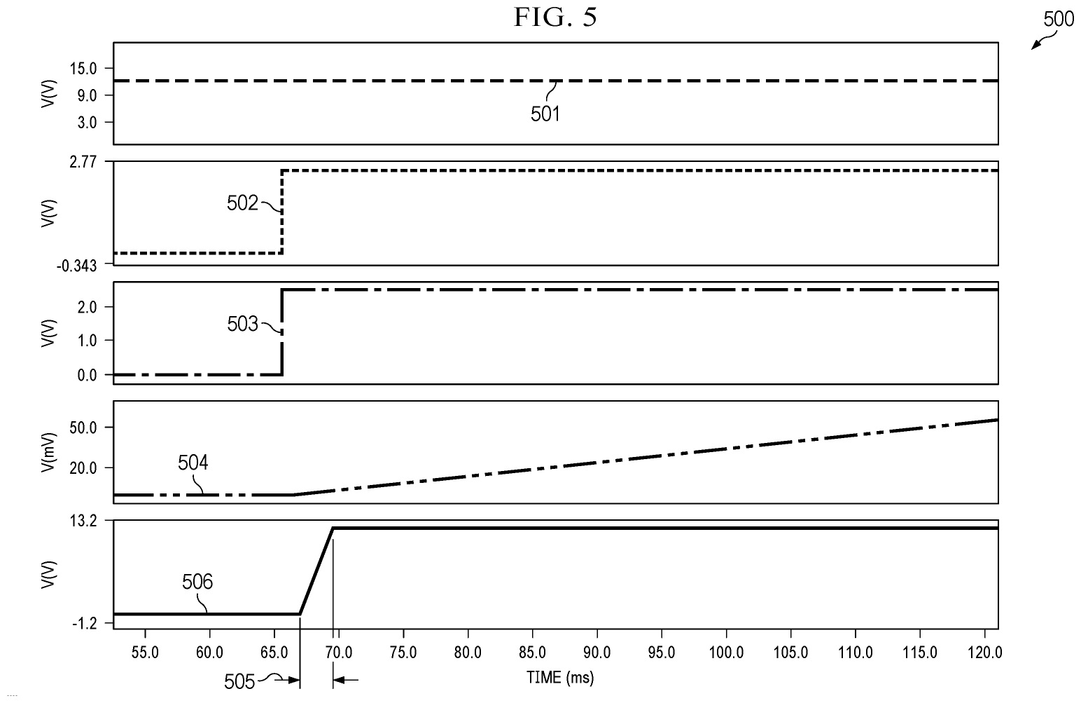

FIG. 5 illustrates a waveform diagram 500 illustrating electrical and timing characteristics according to an embodiment. A pair of top level signals are shown representing Vin 501 and EN_UVLO 502. A switch enable signal (SWEN) 503 is a leaf block (e.g., 407 of FIG. 4) receiving the top level signals 501-502 as inputs and represents an electrical characteristic such as EN_UVLO threshold. A timing characteristic is represented by the waveform 504, which is a logic equation (e.g., logic expression block 410 of FIG. 4) and is used, in part, to model a rise-time delay 505 including slew rate in an output voltage (e.g., Vout) signal 506 in response to the EN_UVLO 502 and SWEN 503 changing to an active state.

Returning to FIGS. 2 and 3, the behavior model 406 may have a number of redundant sample points that accurately represent the functionality of the approved electronic circuit 208 but that can be removed due to the redundant information they provide. The complete model with redundant sample points can be a large file that extends simulation time due to the number of sample points. However, removal of redundant sample points reduces the size of the model file without losing information. Accordingly, the model is reduced or trimmed 211 at block 308 to remove sample points not providing unique device behavior. A decimation process is used to remove redundant sample points.

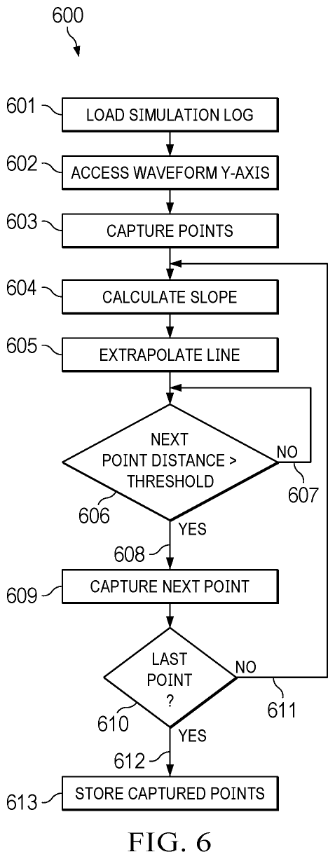

FIG. 6 illustrates a decimation process 600 for trimming the behavior model 406 according to an embodiment. The process 600 begins with loading 601 a simulation log. The y-axis of the simulation log is accessed 602, and a pair of sample points are captured 603. The slope of a line extending between the pair of captured sample points is calculated 604. At 605, the line is extrapolated by extending the line beyond the pair of captured sample points while maintaining the calculated slope. A next point is accessed, and a distance between the next point and the extrapolated line is compared 606 with a threshold. In one example, the threshold is determined based on the signal distribution of the simulation log. If the distance is less than the threshold 607, the information provided by the next sample point is redundant, and it can be removed from the behavior model 406. In this case, the sample points are again accessed to find the subsequent sample point for comparing its distance to the extrapolated line 606.

In response to finding a next or subsequent sample point having a distance to the extrapolated line greater than the threshold 608, it is captured 609 for inclusion in the trimmed model 406. At 610, a determination is made of whether the latest captured sample point is the last sample point in the waveform. If the latest captured sample point is not the last sample point in the waveform 611, the latest captured sample point and the previously captured sample point are paired to calculate the slope of a line therebetween in returning to 604. Iteration of the process steps 604-611 is performed for all remaining sample points in the waveform. In response to evaluating the last sample point 612, all of the captured sample points are stored 613 in the reduced behavior model 406.

Returning to FIGS. 2 and 3, execution of the decimation process 600 leaves sample points contributing to unique device behavior and reduces model development and simulation time. ML model generation 212 of the simulation file generating operation 209 is performed to generate a real number model at block 309. An example of such ML model generation is disclosed in U.S. patent application Ser. No. 18/481,711, entitled “Method and Apparatus for Generating a Real Number Based Circuit Model for Simulation,” filed the same day as the present application, which is incorporated herein by reference in its entirety.

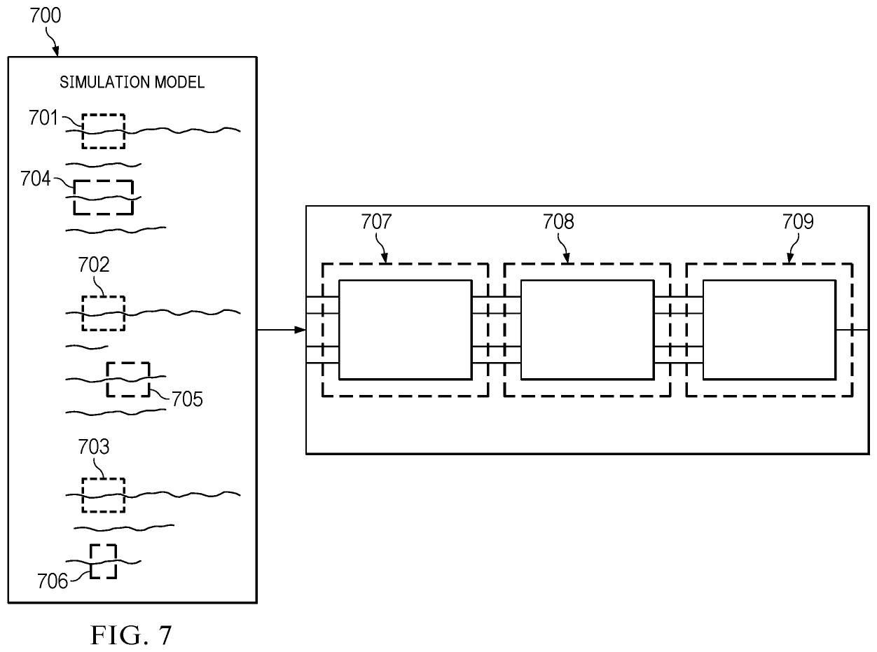

Each model block (e.g., 407-410) has a set of weights generated therefor. The generated weights are used to generate automated simulation program models 213 at block 310. FIG. 7 illustrates a block diagram of a simulation model extraction according to an embodiment. Once the weights are generated for each block, a script may be executed to generate the weights into a SPICE (Simulation Program with Integrated Circuit Emphasis) native simulation language such as PSpice based on integration with a ML-based transfer function. PSpice can model the characteristics of a component design. A SPICE file spice file 700 graphically illustrated shows a plurality of layers 701, 702, 703, each having a plurality of weights 704, 705, 706 and other biases. Based on the layers 701-703 and weights 704-706, SPICE blocks 707, 708, 709 are generated that accurately simulate the approved electronic circuit 208 without revealing the design of the approved electronic circuit 208. The generated SPICE blocks 707-709 are, therefore, genericized and non-discoverable by a third party. The supplier can digitize the SPICE blocks 707-709 and send the simulation file including the digitized blocks to the third party.

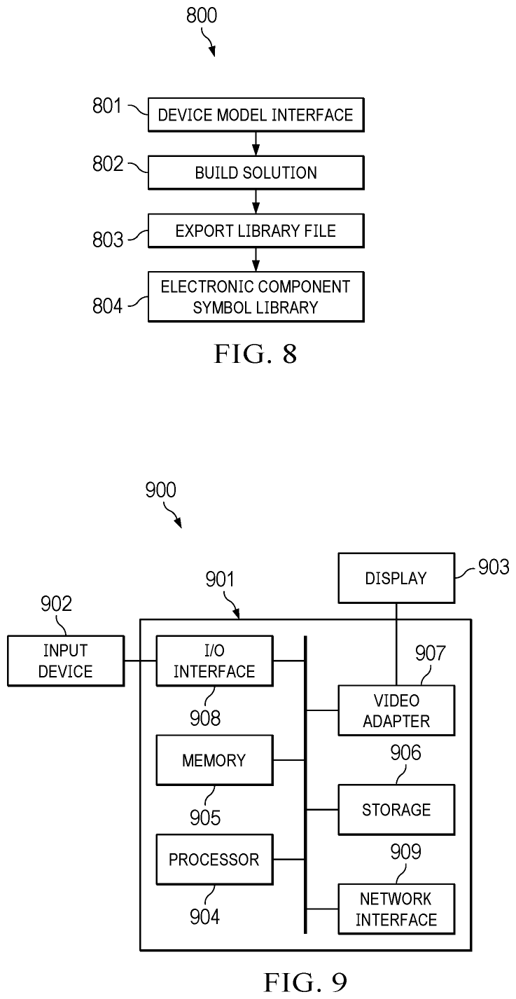

In another embodiment, FIG. 8 illustrates a flow diagram of a process 800 for simulation model extraction based on integrating a ML-based transfer function with device model interface (DMI) model code to create a symbol for each block and set of weights using a computer programming language such as C++, for example. Based on a device model interface 801, a solution is built 802 using an integrated development environment (ICE), which dumps a specific dynamic link library (DLL) file along with model evaluation code. The DLL file is exported 803 to an electronic component symbol library 804 that can be directly used by simulation programs to simulate operation of the approved electronic circuit 208.

Returning to FIGS. 2 and 3, the simulation model generated at block 310 may be subjected to validation 214 by benchmarking or validating the simulation model at block 311 through simulation. Based on the simulation, the performance status is determined at block 312. If the performance status indicates that additional design work is to be performed 313, the approved electronic circuit 208 is modified accordingly to address desired design changes at block 314. The modified approved electronic circuit 208 may be again simulated at block 302 for an iterative process of performance status review (e.g., blocks 302-314). Based on the performance status indicating that the design work is finished and has passed 315, the supplier can manufacture the approved electronic circuit 208 by forming a pattern of the electronic circuit design on a semiconductor wafer to produce the designed electronic circuit in physical form at block 316. In addition, a complete simulation model 215 may be provided to third parties without divulging the specific component arrangement found in the approved electronic circuit 208.

FIG. 9 is a block diagram of an example computer system 900 that may be used to perform electronic circuit design simulation as described herein. For example, the computer system 900 may be used to perform one or more of blocks 307-311 of the operation 300 illustrated in FIG. 3. The computer system 900 includes a processing unit 901 coupled to one or more input devices 902 (e.g., a mouse, a keyboard, or the like), and one or more output devices, such as a display screen 903. The display screen 903 may be used to display progress of the simulation described herein to allow a user to monitor the operational performance of the simulation. In some embodiments, the display screen 903 may be touch screen, thus allowing the display screen 903 to also function as an input device. The processing unit 901 may be, for example, a desktop computer, a workstation, a laptop computer, a tablet, a dedicated unit customized for a particular application, a server, or the like. The display screen 903 may be any suitable visual display unit such as, for example, a computer monitor, an LED, LCD, or plasma display, a television, a high-definition television, or a combination thereof. The display screen 903 can be used, for example, to perform and display the simulation and display the performance status of the simulation such as that described herein.

The processing unit 901 includes a processor 904, memory 905, a storage device 906, a video adapter 907, and an I/O interface 908 connected by a bus. The bus may be one or more of any type of several bus architectures including a memory bus or memory controller, a peripheral bus, video bus, or the like. The processor 904 may be any type of electronic data processor. For example, the processor 904 may be a processor from Intel Corp., a processor from Advanced Micro Devices, Inc., a Reduced Instruction Set Computer (RISC), an Application-Specific Integrated Circuit (ASIC), or the like. The memory 905, e.g., a non-transitory computer-readable medium, can be any type of system memory such as static random-access memory (SRAM), dynamic random-access memory (DRAM), synchronous DRAM (SDRAM), read-only memory (ROM), a combination thereof, or the like. Further, the memory 905 can include ROM for use at boot-up, and DRAM for data storage for use while executing programs.

The storage device 906, e.g., a non-transitory computer-readable medium, can include any type of storage device configured to store data, programs, and other information and to make the data, programs, and other information accessible via the bus. In one or more embodiments, the storage device 906 stores software instructions to be executed by the processor 904 to perform embodiments of the methods described herein. The storage device 906 may be, for example, one or more of a hard disk drive, a magnetic disk drive, an optical disk drive, a solid-state drive, or the like.

The video adapter 907 and the I/O interface 908 provide interfaces to couple external input and output devices to the processing unit 901. The processing unit 901 also includes a network interface 909. The network interface 909 allows the processing unit 901 to communicate with remote units via a network (not shown). The network interface 909 may provide an interface for a wired link, such as an Ethernet cable or the like, or a wireless link. The computer system 900 may also include other components not specifically shown. For example, the computer system 900 may include power supplies, cables, a motherboard, removable storage media, cases, and the like.

This disclosure has attributed functionality to the processing unit 901 and processor 904. The processing unit 901 and processor 904 may include one or more processors. Processing unit 901 and processor 904 may include any combination of integrated circuitry, discrete logic circuitry, analog circuitry, such as one or more microprocessors, microcontrollers, digital signal processors, application specific integrated circuits, central processing units, graphics processing units, field-programmable gate arrays, and/or any other processing resources. In some examples, processing unit 901 and processor 904 may include multiple components, such as any combination of the processing resources listed above, as well as other discrete or integrated logic circuitry, and/or analog circuitry.

The techniques described in this disclosure may also be embodied or encoded in an article of manufacture including a non-transitory computer-readable storage medium, such as memory 905 and storage 906. Example non-transitory computer-readable storage media may include RAM, ROM, programmable ROM, erasable programmable ROM, electronically erasable programmable ROM, flash memory, a solid-state drive, a hard disk, magnetic media, optical media, or any other computer readable storage devices or tangible computer readable media. The term “non-transitory” may indicate that the storage medium is not embodied in a carrier wave or a propagated signal. In certain examples, a non-transitory storage medium may store data that can, over time, change (e.g., in RAM or cache).

The foregoing description of various preferred embodiments of the invention have been presented for purposes of illustration and description. It is not intended to be exhaustive or to limit the invention to the precise forms disclosed, and obviously many modifications and variations are possible in light of the above teaching. The example embodiments, as described above, were chosen and described in order to best explain the principles of the invention and its practical application to thereby enable others skilled in the art to best utilize the invention in various embodiments and with various modifications as are suited to the particular use contemplated. It is intended that the scope of the invention be defined by the claims appended hereto.

1. A method comprising:
creating an electronic circuit design having a plurality of electronic components;
simulating operation of the electronic circuit design;
creating a behavior model of the electronic circuit design;
eliminating one or more data points created in the behavior model to generate a trimmed behavior model;
generating a real number model based on the trimmed behavior model, the real number model comprising a plurality of weights; and
generating a simulation model based on the plurality of weights.

2. The method of claim 1, wherein creating the behavior model comprises:
segmenting characteristics of the electronic circuit design into electrical characteristics and timing characteristics;
assigning each electrical characteristic to a respective electrical block model; and
assigning each timing characteristic to a respective timing block model.

3. The method of claim 2, wherein creating the behavior model further comprises:
determining a behavioral function executable by the electronic circuit design; and
identifying features related to execution of the determined behavioral function;
wherein segmenting the characteristics comprises segmenting characteristics of the identified features into the electrical characteristics and the timing characteristics.

4. The method of claim 2, wherein the respective electrical block model comprises one of a leaf block, a branch block, and a root block; and
wherein the respective timing block model comprises a logic expression block.

5. The method of claim 4, wherein:
the leaf block represents a leaf block model configured to:
receive signals provided externally to the behavior model; and
generate signals provided internally within the behavior model;
the logic expression block represents a logic expression block model configured to:
receive signals provided externally to the behavior model; and
generate counter or timer signals provided internally within the behavior model;
the branch block represents a branch block model configured to:
receive signals provided internally within the behavior model; and
generate signals provided internally within the behavior model; and
the root block represents a root block model configured to:
receive signals provided internally within the behavior model; and
generate an output signal provided externally to the behavior model.

6. The method of claim 5, wherein the branch block model is further configured to receive signals provided externally to the behavior model.

7. The method of claim 1, wherein eliminating the one or more data points comprises:
identifying information provided by a first sample point; and
identifying information provided by a second sample point, wherein the information provided by a second sample point is redundant with the information provided by the first sample point; and
removing the second sample point from the behavior model.

8. The method of claim 1, wherein generating the simulation model comprises:
generating the simulation model based on integrating a machine learning transfer function with a simulation native language based on the plurality of weights.

9. The method of claim 1, wherein generating the simulation model comprises:
generating the simulation model based on integrating a machine learning transfer function with a device model interface (DMI) model code based on the plurality of weights.

10. The method of claim 1, further comprising:
determining a simulated functional operation of the electronic circuit design based on the simulated operation;
comparing the simulated functional operation with an expected functional operation;
modifying the electronic circuit design based on the comparison; and
simulating operation of the modified electronic circuit design;
wherein creating the behavior model comprises creating the behavior model based on the modified electronic circuit design.

11. The method of claim 1, further comprising:
validating the simulation model to confirm performance of the simulation model with expected results; and
forming a pattern of the electronic circuit design on a semiconductor wafer based on the simulation model validation.

12. An apparatus comprising:
one or more computer readable storage media;
program instructions stored on the one or more computer readable storage media, the program instructions executable by a processing system to direct the processing system to:
simulate operation of an electronic circuit design;
create a behavior model of the electronic circuit design, the behavior model comprising a plurality of data points;
trim at least one data point from the behavior model to reduce a size of the behavior model;
generate a real number model based on the trimmed behavior model, the real number model comprising a plurality of weights; and
generate a simulation model based on the plurality of weights.

13. The apparatus of claim 12, wherein the program instructions further direct the processing system to:
segment characteristics of the electronic circuit design into electrical characteristics and timing characteristics;
assign each electrical characteristic to a respective electrical block model; and
assign each timing characteristic to a respective timing block model.

14. The apparatus of claim 13, wherein the respective electrical block model comprises one of a leaf block, a branch block, and a root block; and
wherein the respective timing block model comprises a logic expression block.

15. The apparatus of claim 14, wherein:
the leaf block represents a leaf block model configured to:
receive signals provided externally to the behavior model; and
generate signals provided internally within the behavior model;
the logic expression block represents a logic expression block model configured to:
receive signals provided externally to the behavior model; and
generate counter or timer signals provided internally within the behavior model;
the branch block represents a branch block model configured to:
receive signals provided internally within the behavior model; and
generate signals provided internally within the behavior model; and
the root block represents a root block model configured to:
receive signals provided internally within the behavior model; and
generate an output signal provided externally to the behavior model.

16. The apparatus of claim 15, wherein the branch block model is further configured to receive signals provided externally to the behavior model.

17. The apparatus of claim 12, wherein the program instructions that direct the processing system to trim the at least one sample point further direct the processing system to:
remove the at least one sample point from the behavior model, the at least one sample point having model information redundant with a sample point remaining within the behavior model.

18. The apparatus of claim 12, wherein the program instructions that direct the processing system to generate the simulation model further direct the processing system to:
generate the simulation model based on integrating a machine learning transfer function with a PSpice native language based on the plurality of weights.

19. The apparatus of claim 12, wherein the program instructions that direct the processing system to generate the simulation model further direct the processing system to:
generate the simulation model based on integrating a machine learning transfer function with a device model interface (DMI) model code based on the plurality of weights.

20. The apparatus of claim 12, wherein the program instructions further direct the processing system to:
benchmark the simulation model to confirm performance of the simulation model with expected results.
